(19) United States
(12) Patent Application Publication
(10) Pub. No.: US 2026/0105787 A1
(43) Pub. Date: Apr. 16, 2026

(54) SYSTEM AND METHOD FOR DETERMINING PRODUCTIVITY OF MOBILE MACHINES

(71) Applicant: Caterpillar Inc., Peoria, IL (US)

(72) Inventors: Gowtham Krishnan, Chennai (IN); Sai Praveen Gundlapalli, Chennai (IN); Gautham Subramanian, Semmancheri (IN)

(73) Assignee: Caterpillar Inc., Peoria, IL (US)

(21) Appl. No.: 18/915,461

(22) Filed: Oct. 15, 2024

(51) Int. Cl. G07C 5/02; G01M 99/00; E01C 19/26

(52) U.S. Cl. CPC G07C 5/02; G01M 99/00; E01C 19/26

(57) ABSTRACT

A method for determining productivity of a machine includes generating a grid in a virtual map; detecting at least one pass executed by an object with respect to grid cells; determining a first set of cells for which a count of passes exceeds a count threshold; measure a first and a second elevation data of the machine corresponding to each cell of the first set of cells when the object correspondingly executes a first pass and a second pass with respect to said each cell; comparing the second and first elevation data corresponding to said each cell to compute an elevation change; identifying a second set of cells from the first set of cells for which the elevation change exceeds an elevation threshold; clustering the second set of cells to define a work region; and calculating a volume of earth altered based on the work region to determine the productivity.

### TECHNICAL FIELD

The present disclosure relates to machines operable at a worksite. More particularly, the present disclosure relates to a system and a method for determining productivity of mobile machines or productive work areas at the worksite.

### BACKGROUND

Construction may sometimes involve operations, such as compaction, milling, scraping, paving, of surfaces, at a worksite. To perform such operations, mobile machines, such as compactors, dozers, graders, and other types of machines often applied to alter a surface at a worksite, may be employed. In performing their respective operations, such machines may execute a specific type of motion across multiple portions of worksites. In one example, a dozer may be moved from one location to another with its blade engaged with the ground for removing and relocating one or more layers of the surface. These layers may include gravel, concrete, asphalt, soil, rocks, or any combination thereof. In another example, a compactor may be moved with its compacting roller drum used to compact a surface.

If a movement of such machines alone were a parameter for determining productivity, it becomes difficult to ascertain whether such movement executed by the machines were for the purposes of travel or for the purposes of work, e.g., dozing or compacting. Therefore, an actual work performed, e.g., a volume of earth altered by such machines, and thus the machine’s associated productivity is calculated incorrectly and therefore, leads to the machine’s total work output per unit time being reflected improperly or inaccurately. This in turn leads to loss of capital, mismanaged machine fleet, or unrequited expenditure of man-hours in correcting and arriving at the actual volume of earth altered or the actual machine’s productivity.

United States Patent 9,169,605 relates to a system for determining a state of compaction of a work material. The system includes a compactor and a compaction sensor system. A controller is configured to determine an empirical state of compaction of the work material based upon signals from the compaction sensor system and the characteristics of a machine associated with the compaction sensor system. Improvements in measurement of productivity of such machines are required to more accurately estimate or determine productivity.

Hence, there is a need for a system that is able to clearly and effectively distinguish between travelled areas and travelled and worked areas so that an associated machine’s total work output is computed correctly and reported for assessing the productivity of the machine besides calculating payloads delivered using that machine.

### SUMMARY

In one aspect, the present disclosure discloses a method for determining productivity of a mobile machine that is configured to alter earth at a worksite. The method includes generating a grid in a virtual map of the worksite. The grid defines multiple cells. The method includes detecting at least one pass executed by an object with respect to the cells in the virtual map. The object is representative of the mobile machine. Further, the method includes determining a first set of cells among the cells for which a count of passes exceeds a count threshold. Next, the method includes using a sensor system to measure a first elevation data and a second elevation data of the mobile machine corresponding to each cell from within the first set of cells when the object correspondingly executes a first pass and a second pass with respect to each cell from within the first set of cells. The method includes comparing the second elevation data with the first elevation data corresponding to each cell from within the first set of cells to compute an elevation change for each cell from within the first set of cells and identifying a subset of cells or a second set of cells from within the first set of cells for which the elevation change exceeds an elevation threshold. Moreover, the method includes clustering the second set of cells together to define a work region in the virtual map of the worksite and calculating a volume of earth altered by the mobile machine based on the work region to determine the productivity of the mobile machine.

In another aspect, the disclosure relates to a system for determining productivity of a mobile machine configured to alter earth at a worksite. The system includes a sensor system and a system. The sensor system is configured to measure an elevation data of the mobile machine. The system is configured to generate a grid in a virtual map of the worksite. The grid defines a number of cells. The system is configured to detect at least one pass executed by an object with respect to the cells in the virtual map. The object is representative of the mobile machine. Further, the system is configured to determine a first set of cells of the plurality of cells for which a count of passes exceeds a count threshold and use the sensor system to detect a first elevation data and a second elevation data of the mobile machine corresponding to each cell from within the first set of cells when the object correspondingly executes a first pass and a second pass with respect to each cell from within the first set of cells. Further, the system is configured to compare the second elevation data with the first elevation data corresponding to each cell from within the first set of cells to compute an elevation change for each cell from within the first set of cells and identify a subset of cells or a second set of cells from the first set of cells for which the elevation change exceeds an elevation threshold. The system is configured to cluster the second set of cells together to define a work region in the virtual map of the worksite, and, further, calculate a volume of earth altered by the mobile machine based on the work region to determine the productivity of the mobile machine.

### BRIEF DESCRIPTION OF THE DRAWINGS

FIG. 1 is a diagrammatic top view of an exemplary worksite showing multiple machines to alter a surface of the worksite, in accordance with an embodiment of the present disclosure;

FIG. 2 is a schematic view of a system for determining productivity of the machines of FIG. 1, in accordance with an embodiment of the present disclosure;

FIG. 3 is a virtual map of the worksite of FIG. 1 that is displayed using a user interface (UI) of the system of FIG. 2, in accordance with an embodiment of the present disclosure;

FIG. 4 is an exemplary view of bounding box data created in the virtual map of the worksite, in accordance with an embodiment of the present disclosure;

FIG. 5 is an exemplary view of a grid generated in the virtual map of the worksite based on the bounding box data, in accordance with an embodiment of the present disclosure;

FIG. 6 is a close-up view of a region of the virtual map that corresponds to a worked area of the worksite, in accordance with an embodiment of the present disclosure;

FIG. 7 is another close-up view of the region of the virtual map of FIG. 6 showing a first set of cells defined by the grid of FIG. 5, in accordance with an embodiment of the present disclosure;

FIG. 8 is yet another close-up view of the region of the virtual map of FIG. 6 showing a subset of cells or a second set of cells defined by the grid of FIG. 5, in accordance with an embodiment of the present disclosure; and

FIG. 9 is a flowchart illustrating a method for determining productivity of the machines, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1`, 1``, 101 and 201, could refer to one or more comparable components used in the same or different depicted embodiments.

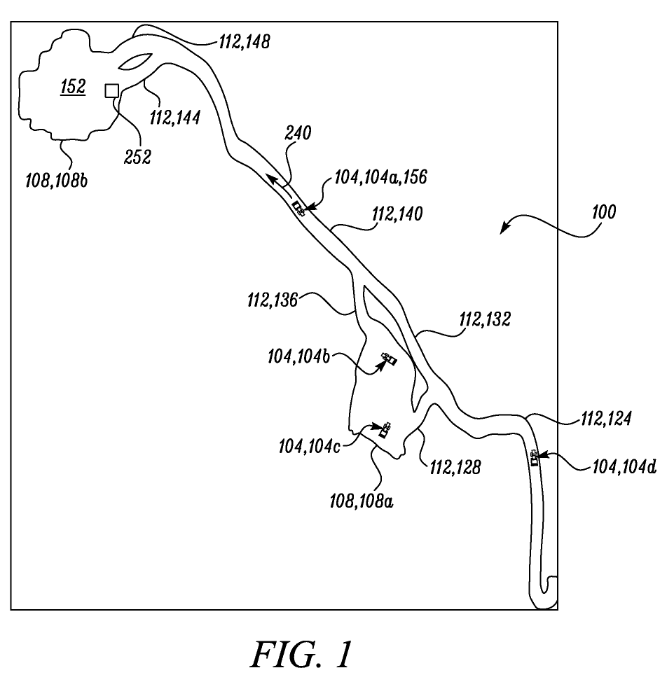

Referring to FIG. 1, a worksite 100 is described. The worksite 100 may include or correspond to a mining site, a construction site, a quarry, a landfill, or any other worksite known to persons skilled in the art. The worksite 100 may employ one or more machines 104 for performing operations at the worksite 100. In the illustrated example, the worksite employs 4 machines 104 – namely 104a, through 104d. Although 4 machines are depicted, the number of machines depicted is merely exemplary and illustrative in nature. In other examples, the number of machines deployed may be less than or more than 4 depending on specific requirements of an application.

For example, the worksite 100 may include one or more areas on which the machines 104 may perform work. The machines 104 may include a compactor 156 as will discussed below. Also, the worksite 100 may include areas on which the machines 104 may travel. Areas of the worksite 100 on which the machines 104 may perform work or on which the machines 104 may have already performed work may be referred to as worked areas 108. Areas of the worksite 100 on which the machines 104 may travel may be referred to as a travel areas 112. The worksite 100 may include a number of worked areas 108. As an example, the worksite 100 may include a first worked area 108a and a second worked area 108b, as shown. A different number of worked areas 108 may be contemplated, and those noted above are exemplary and illustrative in nature.

Further, the worksite 100 may include a number of travel areas 112. As an example, the worksite 100 may include seven travel areas, namely, a first travel area 124, a second travel area 128, a third travel area 132, a fourth travel area 136, a fifth travel area 140, a sixth travel area 144, and a seventh travel area 148, as shown. A different number of travel areas 112 may be provided at the worksite 100, and those noted above are exemplary. By using the fourth travel area 136, the fifth travel area 140, and the sixth travel area 144, one or more of the machines 104 may travel between the first worked area 108a and the second worked area 108b. In the illustrated example of FIG. 1, the travel areas 112 may be regarded as a travel route for the machine 104 to allow the machines 104 to travel between the pair of worked areas 108a, 108b.

It may be noted that a travel area can extend from a work area to allow for a machine to enter and exit the corresponding work area. In some cases, travel areas may extend between two work areas to allow for machines to enter or exit either of the two work areas and travel between the two work areas. In some other cases, travel areas may run alongside two or more work areas such that a single contiguous travel area allows for machines to enter or exit any of the work areas within the worksite 100. In other cases, there may be a travel area, e.g., the sixth travel area 144, dedicated to facilitating entry alone to a work area, e.g., the second worked area 108b, while another travel area, e.g., the seventh travel area 148, is provided for facilitating exit alone from such a work area.

Although not limited, the machines 104 applied at the worksite 100 may include mobile machines, and, more particularly, those mobile machines that may be moved not only for achieving travel, but also for performing work. Work performed by the machines 104 may involve altering earth. ‘Altering earth’, and similar expressions used in the present disclosure, may include or exemplarily mean changing an elevation of a surface. As an example, see surface 152, FIG. 1, defined at the second worked area 108b of the worksite 100.

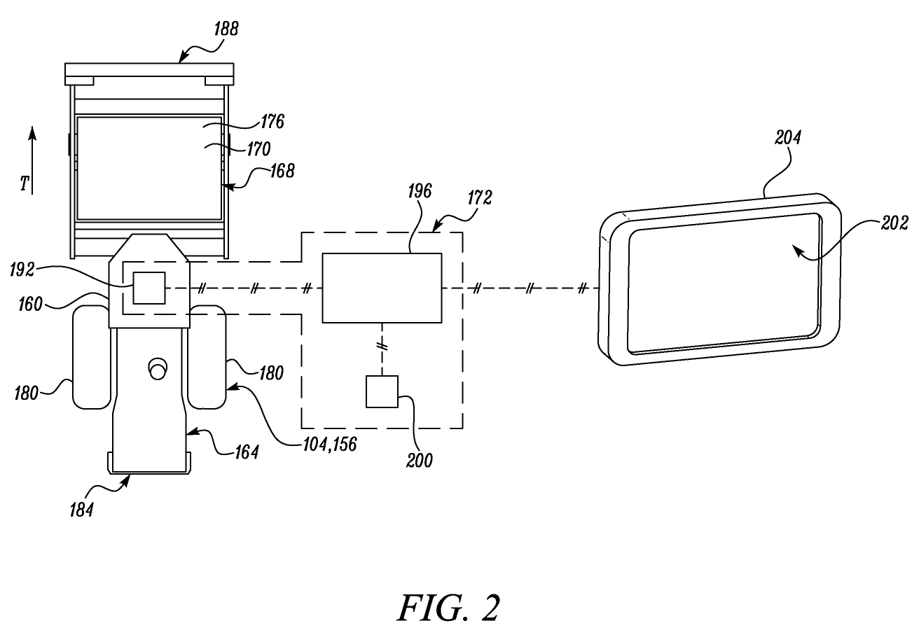

Referring to FIG. 2, for the purposes of the present disclosure, the compactor 156 has been described as the machine 104. The compactor 156 is shown in FIG. 2 alongside a system 172 that may be applied for determining productivity of the compactor 156.

The compactor 156 may include a frame 160 and a power system 164 supported on the frame 160. The compactor 156 may also include various sub-systems which may be powered by the power system 164. As an example, one of the sub-systems may include an implement system 168. The implement system 168 may include an implement 170, such as one or more compaction drums (see compaction drum 176) which may be operated to achieve a compaction, such as an earth altering operation of the surface 152 associated with the second worked area 108b of the worksite 100. With regard to the surface 152, the compaction operation may involve an application of pressure on the surface 152 that may cause compression and densification of an underlying material, such as soil, concrete, asphalt, or landfill, of the surface 152, helping the compactor 156 achieve an acceptable surface finish on the surface 152. In some embodiments, depending on a type of the machine e.g., a grader, a dozer, or an excavator, the implement system 168 may vary to include a moldboard or a blade or a bucket, respectively, to enable the machine 104 to grade or move material from one location to another within the worksite 100.

Further, as an example, the sub-systems of the compactor 156 may include one or more traction devices 180. The traction devices 180 of the compactor 156 may include wheels, or tracks, or a combination thereof, and which may be powered to propel the compactor 156 to various locations, such as to the second worked area 108b, of the worksite 100. The traction devices 180 may be powered by the power system 164 of the compactor 156. In some embodiments, the compactor 156 may include multiple compaction drums, such as the compaction drum 176, one or more of which may also work to provide traction and thus mobility to the machine 104 at the worksite 100. In cases where the compactor 156 may include multiple compaction drums, such as a forward compaction drum and a rearward compaction drum (not shown), traction devices 180, such as wheels and/or crawlers, may be substituted with these compaction drums from the machine 104. In some embodiments, the compactor 156 may include landfill compactors having a toothed compaction drum to aid traction over the surface 152, and, in which case, the second worked area 108b of the worksite 100 may include a landfill.

The compaction operation, i.e., work performed by the compactor 156 may include moving or rolling the compaction drum 176 over the surface 152 to compact the underlying material to a suitable extent of compaction. In some embodiments, the compaction operation may be supplemented by vibrations induced into the compaction drum 176 during the movement or rolling of the compaction drum 176 over the surface 152. The compactor 156 may simply be referred to as a machine 104 in order to indicate that the aspects of the present disclosure are also applicable to various other machines, such as those that are noted above, and it will be appreciated that references to the compactor 156 are purely exemplary.

Although the present disclosure is explained in conjunction with, and reference to, the compactor, aspects of the present disclosure can be similarly applied to other machines. As such, these types of mobile machines may also be operated to alter earth. For example, such machines may include dozing machines that may carry out dozing operations, including earth moving, material piling, etc., by use of a blade or a moldboard; paving machines that may perform road laying or pavement laying operations; and milling machines that may engage and scrape off one or more layers of a road surface. In some embodiments, the machine 104 may also include or be representative of hydraulic excavators, shovels, loaders, scrapers, cold planers, and similar machines known to persons skilled in the art.

It may be noted that the terms ‘front’ and ‘rear’, and similar terms, as have been used herein, are in relation to an exemplary forward direction of travel of the machine 104, as represented by arrow, T, in FIG. 2, in which the machine 104 may generally travel so as to move or shuttle between the various areas, such as between the first worked area 108a and the second worked area 108b of the worksite 100. Also, said forward direction of travel, T, is defined from a rear end 184 of the machine 104 towards a front end 188 of the machine 104.

With continued reference to FIG. 2, the system 172 for determining the productivity of the machine 104 includes a sensor system 192 and a system 196. The system 196 may be a control system. As an example, the sensor system 192 may be coupled with the sub-systems of the machine 104. The sensor system 192 may include any number and variety of sensors that are configured to sense a variety of measurable operational parameters of the machine 104. As an example, the measurable operational parameters include the machine’s operation, such as machine’s motion, the implement system’s state, etc., or the machine’s condition, such as an elevation, orientation, or a location of the machine 104, at the worksite 100. The sensor system 192 may include, but is not limited to, one or more of inertial measurement units (IMU sensors), accelerometers, inclinometers, thermometers, proximity sensors, magnetometers, barometers, seismometer, pressure sensors, and acoustic sensors, location systems such as global positioning systems (GPSs), and various other types of sensors known to persons skilled in the art. Based on their type, such sensors of the sensor system 192 would generate and output corresponding type of measurement data. In an embodiment herein, at least one sensor (not shown) from the sensor system 192 may be configured to measure an elevation of the implement 170 while another sensor may be configured to measure an elevation of the frame of the machine 104 relative to the surface 152. It is hereby envisioned that the sensor system 192 of the present disclosure would be capable of generating and providing elevation data of the machine 104 and the implement 170.

Data generated by the sensor system 192 may correspond to machine telematics data, commonly referred to as ‘TAG’ files, and may be collected and processed by a recipient, such as the system 196. In doing so, the system 196 may determine one or more aspects including, but not limited to, a geographical location of the machine 104 at the worksite 100, a duration for which the machine 104 is operational, functions or implements used by the machine 104 for accomplishing a specific task, a specification of the machine 104, a health status of the machine 104, and chronology of events from the timestamps. As an example, the specification of the machine 104 may include or correspond to a size or an operational capacity of the implement system 168, an indication of the manual, autonomous, or remote control capabilities of the machine 104, the type of fuel consumed by the machine 104, physical dimensions of the machine 104, an identifier for the machine 104, such as a license plate, a vehicle identification number (VIN), and a media access control (MAC) address which may be associated with one or more controllers or communication devices of the machine 104, and other specification known to persons skilled in the art.

The system 196 may be configured to receive the data. As an example, the system 196 may receive data by electrical transmission means, which may include, for example, a wired, a wireless communication network, and data links, such as a Controller Area Network (CAN). In one example, the data may be used by the system 196 at the end of a work shift, or, in some cases, during the work shift, to indicate a progress with regard to a level and an accuracy of completion of any task or any part of a task, i.e., work performed, and the same may be used/presented as progress indicators – also referred to as key progress indicators (KPIs). In other words, the KPIs may be any type of measurement arrived at, by the system 196, by using the telematics data to evaluate a level or a percentage of completion of a task executed by the machine 104, e.g., when said task is compared with a predetermined worksite plan. In one example, the system 196 may process data by retrieving or using maps, look-up tables, neural networks, algorithms, machine learning algorithms, or other components, such as from a memory 200, to present and formulate the data as one or more KPIs.

Upon obtaining data from sensor system 192, the system 196 may report production metrics of various types. In one example, the system 196, which may optionally include any electronic or communication devices, or any other components of the system 196, may continuously or periodically send requests to one or more communication devices associated with the machine 104 or the sensor system 192 requesting the telematics data, such as data obtained from the sensors or data associated with the progress indicators, to be transmitted to the system 196. In alternate embodiments, the sensor system 192 may be inherently calibrated to transmit the data, at least in part, continuously or periodically, to the system 196, such as to any electronic or communication devices, or any other component associated with the system 196.

In some embodiments, the system 196 or any other entity may use the KPIs to identify underperforming machines from the many machines that may be present at the worksite 100 or inefficient machine operators vis-à-vis the predetermined worksite plan, enabling supervisors, foremen, site managers, crew members, or other individuals associated with the worksite plan, to know how far along the machine 104 has been able to complete a designated task, and with what efficiency those tasks were completed. The KPIs may be presented on a user interface (UI) 202 on one or more display devices (see display device 204 in FIG. 2) associated with the machine 104 or the display devices associated with the system 172. With the display of these production metrics, a user, such as the supervisors, site managers, crew members, or other individuals associated with the worksite plan, may understand each individual production metric as defined by the KPIs and confer whether steps need to be taken, such as by operators of the machine 104, to resolve any inefficiency for executing the task.

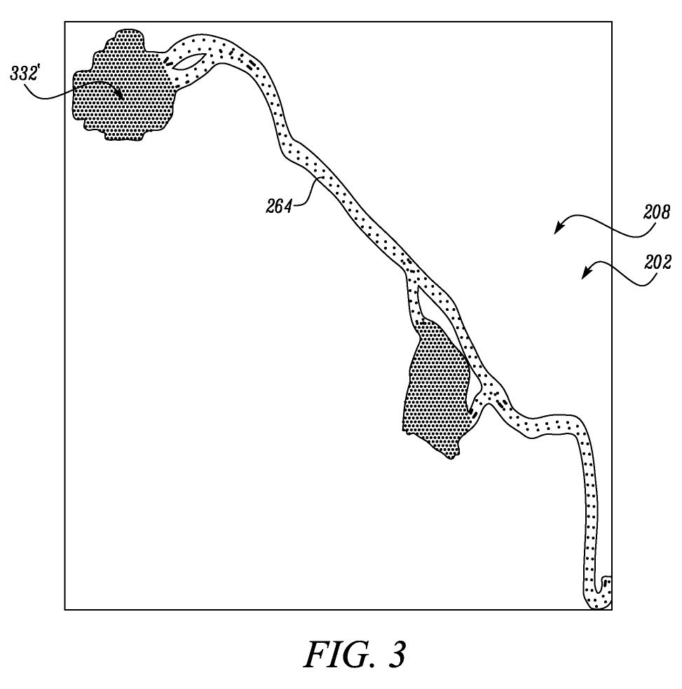

Referring to FIGS. 3 through 8, and for determining the productivity of the machine 104, the system 196, such as upon a request, retrieves a set of instructions from the memory 200 and executes the set of instructions. Upon execution of the set of instructions, the system 196 retrieves a virtual map 208 of the worksite 100 from the memory 200. As an example, the virtual map 208 may be prestored in the memory 200. In an embodiment, the virtual map 208 may be produced dynamically by the system 196. A dynamic production of the virtual map 208 may be attained at an end of a work shift or at a time when the machine’s productivity is to be determined or at any other appropriate time as desired by a site supervisor, a frequency of which may be preset or selected beforehand by the site supervisor.

With regard to the dynamic production of the virtual map 208, the system 196 may receive information from one or more sensors, such as in situ or on-field sensors, or even sensors onboard the machine 104, which may include 3-dimensional (3D) sensors, Light Detection and Ranging (LIDAR) sensors, and other sensors known to persons skilled in the art, physically deployed at various locations of the worksite 100, externally to the machine 104, to analyze physical characteristic of the worksite 100. Such information may be processed by the system 196 to produce the virtual map 208. In some embodiments, the system 196 may use a device, such as the display device 204, to display the virtual map 208 thereon to one or more users, machine operators, and to site supervisors.

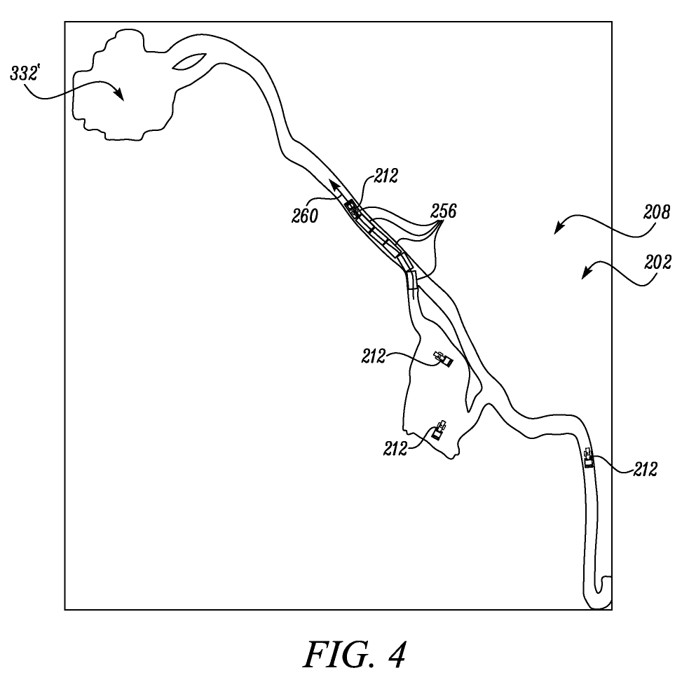

Further, in some embodiments, the system 196 is configured to locate the machine 104 at the worksite 100. In this regard, the system 196 retrieves data from the sensor system 192, for example, from the location systems, such as the GPS of the sensor system 192. Based on the retrieved data, the system 196 creates an object 212 (refer FIG. 4) in the virtual map 208 to represent the machine 104 at the worksite 100. A position of the object 212 in the virtual map 208 effectively corresponds to the location of the machine 104 at the worksite 100. By way of such correspondence, a movement of the object 212 in the virtual map 208 occurs coterminous with a motion of the machine 104 at the worksite 100. Although not limited to specific examples disclosed herein, the object 212 may take the form of, for example, an icon, a graphical dataset, an image corresponding to the machine 104, or other forms of iconography commonly known for representing position and indicating movement of the machine 104, and indicating movement of the implement, on the virtual map 208 for intuitive and therefore, easy comprehension by a viewer, such as a site supervisor, viewing the virtual map 208 displayed on the display device 204.

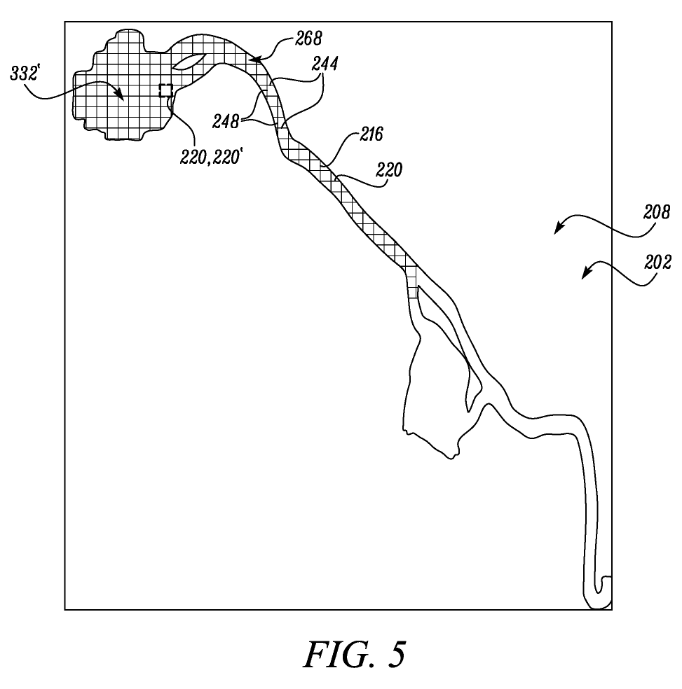

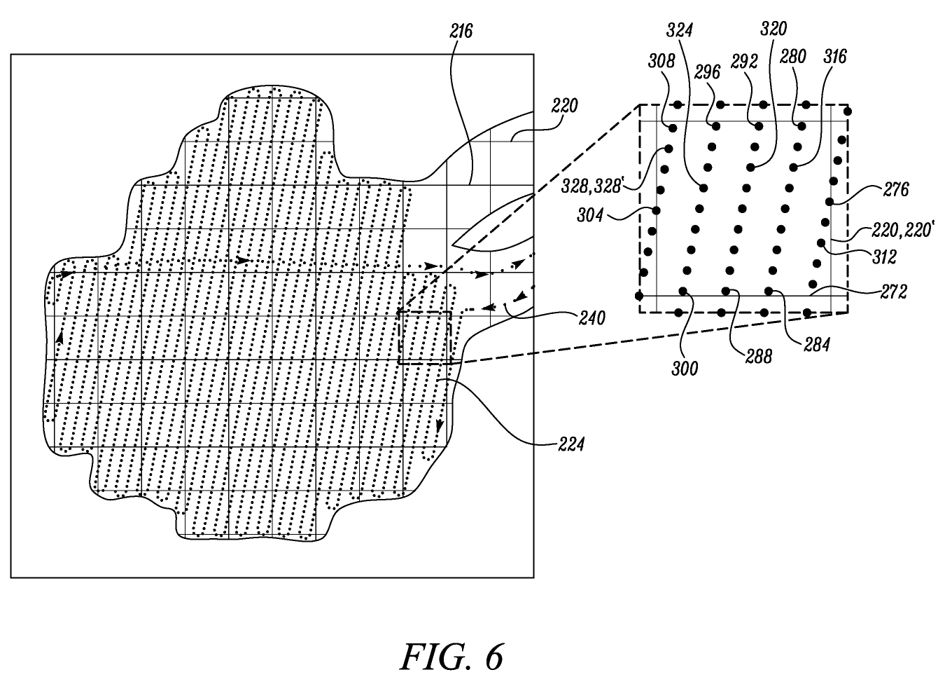

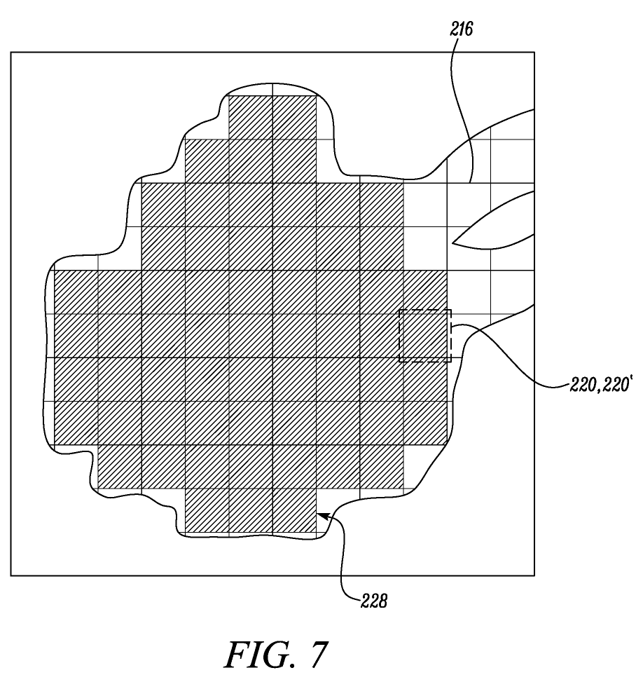

Further, based on executing the set of instructions, the system 196 is configured to generate a grid 216 (refer FIG. 5) in the virtual map 208 of the worksite 100. The grid 216 defines a number of cells 220 – only one cell 220 is indicated in FIG. 5. The system 196 also is configured to detect one or more passes 224 (refer FIG. 6) executed by the object 212 with respect to the cells 220 in the virtual map 208. More particularly, the system 196 is configured to determine a first set of cells 228 (refer FIG. 7) of the number of cells 220 for each of which a count of the passes 224 exceeds a count threshold. Only few cells 228 are marked. Also, the system 196 is configured to use the sensor system 192 to measure a first elevation data and a second elevation data of the machine 104 corresponding to each cell 228 of the first set of cells 228 when the object 212, representative of the machine 104, correspondingly executes a first pass and a second pass (see passes 224, FIG. 6) with respect to each cell 228 of the first set of cells 228.

The system 196 is further configured to compare the second elevation data with the first elevation data corresponding to each cell 228 of the first set of cells 228. In so doing, the system 196 computes an elevation change for each cell 228 of the first set of cells 228. Additionally, the system 196 is configured to identify a subset of cells or a second set of cells 232 from the first set of cells 228 for which the elevation change exceeds an elevation threshold. Once the second set of cells 232 are identified, the system 196 is configured to cluster the second set of cells 232 together to define a work region 236 in the virtual map 208 of the worksite 100. Moreover, the system 196 is also configured to calculate a volume of earth altered by the machine 104 based on the work region 236 to determine the productivity of the machine 104. Further details related to such functionality is described later in the present disclosure.

It will be appreciated that the work region 236, as defined by the system 196 by clustering the second set of cells 232, may define a productive work area in the virtual map 208 of the worksite 100. The productive work area may form a parameter for any subsequent analysis, and, therefore, it should be noted that such parameter is limited to its application for calculating the volume of earth altered alone. In some embodiments, the system 172 may be applied to merely deduce said work region 236, in other words, the productive work area, as well. The system 172, in such a case, may thus simply correspond to a system which may be applied to determine the productive work area.

The system 196 may correspond to one or more controllers which may be communicably coupled to the machine’s main control module (not shown), such as a safety module or a dynamics module, or may be configured as a stand-alone entity. Optionally, the system 196 may be integral to or be one and the same as the machine’s main control module. In some embodiments, one or more controlling portions of the system 196 may be within the machine 104, while the other controlling portions may be situated outside the machine 104, i.e., remotely to the machine 104. In some embodiments, the system 196 may be positioned entirely outside the machine 104, i.e., remotely from the machine 104.

Further, the system 196 may include a microprocessor-based device, or the system 196 may be envisioned as an application-specific integrated circuit, or other logic devices, which provide controller functionality, and such devices or systems being known to those with ordinary skill in the art. In some embodiments, the set of instructions may be provided in any computer readable media, for example, any non-transitory computer readable media, and that when executed by the system 196 may result in one or more of the functions of the system 196 to be realized consistently with that disclosed the present disclosure.

In one example, it is possible for the system 196 to include or be representative of one or more control systems having separate or integrally configured processing units to process a variety of data, such as input or commands or signals incoming from the sensor system 192, each of which may be set for the performance of one or more functions of the machine 104, as have been described for the system 196 in the present disclosure. In some embodiments, a transmission of data between the system 196 and various other systems or devices, such as the sensor system 192 or the communication devices associated with the sensor system 192, etc., may be facilitated wirelessly or through a standardized CAN bus protocol. Although not limited, the system 196 may be optimally suited for accommodation within certain panels or portions, such as machine panels or portions, from where the system 196 may remain accessible for ease of use, service, calibration, repairs, and replacements.

Processing units or any one or more processors associated with the system 196, to convert or process various input, command, signals, etc., may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor now known or in the future developed.

Examples of the memory 200 may include a hard disk drive (HDD), and a secure digital (SD) card. Further, the memory 200 may include non-volatile/volatile memory units such as a random-access memory (RAM) / a read only memory (ROM), which may include associated input and output buses. The memory 200 may be configured to store various other instruction sets for various other functions of the machine 104, along with the set of instruction, described above. Although not limited, the memory 200 may be configured within and may form part of the system 196, in some cases.

### INDUSTRIAL APPLICABILITY

During an operational work cycle, to perform work by way of the machine 104 such as at the second worked area 108b of the worksite 100, the machine 104 may be moved to the second worked area 108b. If the machine 104 were at the first worked area 108a, the machine 104 may use or move through the fourth travel area 136, the fifth travel area 140, and the sixth travel area 144, such as in sequence, to reach up to the second worked area 108b from the first worked area 108a. Having reached up to the second worked area 108b, the machine 104 may perform the work, such as the earth altering operation including a compaction operation, at the second worked area 108b. As the machine 104 may be a mobile machine which may perform work as it moves, the machine 104 may move throughout the second worked area 108b in a desired manner along path 240 (refer FIG. 1 and FIG. 6) such that as the machine 104 moves along the path 240, the machine 104 may also concomitantly perform work, such as the compaction operation, over the surface 152.

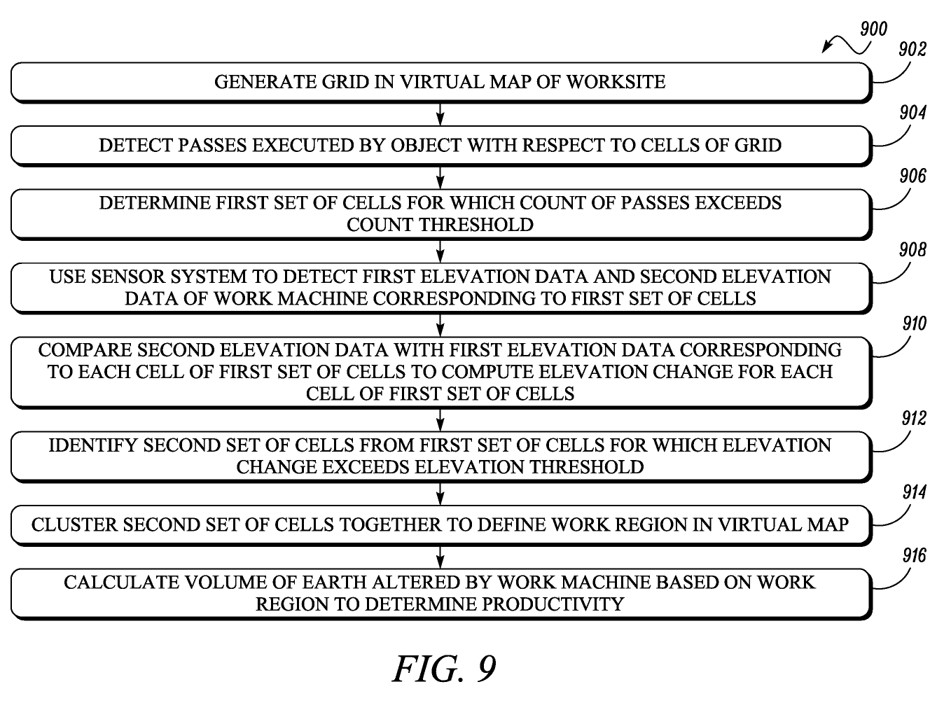

Hereinafter, the present disclosure describes a method by way of which the productivity of the machine 104 may be determined. The method is discussed below with reference to a flowchart 900 illustrated in FIG. 9. Said method is also discussed in conjunction with FIGS. 1 through 8. The method starts at block 902.

At block 902, during the operation work cycle or at the end of the operation work cycle, once the virtual map 208 of the worksite 100 is retrieved, e.g., by the system 196, or produced (refer FIGS. 4 through 6), the system 196 generates the grid 216 in the virtual map 208. As exemplarily shown in FIG. 5, the grid 216 includes or is formed by a first set of reference lines 244 and a second set of reference lines 248, as shown in FIG. 5. It may be noted that only few reference lines are marked while others have been deliberately omitted for sake of clarity and ease of understanding. The first set of reference lines 244 may cross the second set of reference lines 248. The first set of reference lines 244 may cross or be disposed orthogonally or at right angles to the second set of reference lines 248. The layout of the first set of reference lines 244 and the second set of reference lines 248 may define an array of the cells 220 of the grid 216, as shown. The cells 220 may be identical to each other, such as the cells 220 may be same or uniform in shape or in size or may correspondingly define same areas. As an example, each cell 220, e.g., cell 220` (refer FIG. 5), may correspond to a section 252 (refer FIG. 1) within an area of the worksite 100, such as within the second worked area 108b of the worksite 100. In one example, the section 252 within the area, such as the second worked area 108b, of the worksite 100 may define a corresponding area, which, in some embodiments, may equal to one square meter (i.e., 1.0 m²). Each cell from the array of cells 220 in the grid 216 may be square shaped. In an embodiment, the cells 220 in the grid 216 may be rectangular shaped or polygonal shaped. In an embodiment, it is contemplated that an aspect ratio of each of the cells 220 may vary from one application to another to suit specific requirements of an application.

Further, it will be appreciated that the sizes of the cells 220 are exaggerated in the FIGS. 5 through 8. This is to ease visualization and reference in said FIGS. 5 through 8. Actual sizes of the cells 220 may be much smaller than what has been illustrated in the FIGS. 5 through 8, and by way of which the cells 220, through a maximum possible resolution depending on computational resources, bandwidth, and efficiency, may better cover and/or be spread out across a region in the virtual map 208 corresponding to the second worked area 108b of the worksite 100. Such extensive and detailed coverage or spread of the cells 220 may enhance accuracy when determining the productivity of the machine 104. As an example, the cells 220, defined by way of the generation of the grid 216, may be sized similar as pixels, and, therefore, in some embodiments, the cells 220 may define a smallest discrete sized element or the smallest building block of the virtual map 208.

In some embodiments, the grid 216 may be generated by the system 196 based on the movement of the object 212 in the virtual map 208. In this regard, and as an example, the system 196 may create bounding box data for the object 212 in the virtual map 208. The bounding box data may include one or more bounding boxes 256 generated in series, corresponding to the movement of the object 212 in the virtual map 208, i.e., in accordance with the motion of the machine 104 at the worksite 100. As an example, the bounding boxes 256 may be constituted in alignment along a track 260 (refer FIG. 4) formed by the movement of the object 212 in the virtual map 208 which in turn corresponds or follows the path 240 of the machine 104 as the machine 104 may move and enter into the second worked area 108b. In one example, the track 260 in the virtual map 208 may be determined by the system 196 according to periodic timestamps generated for the object 212 as the object 212 executes movement in the virtual map 208. Such timestamps may provide a trail 264 (refer FIG. 3) associated with the object 212 in the virtual map 208, thus enabling the perception of the track 260 by the system 196. One or more of the bounding boxes 256 may be then split to generate the grid 216.

In one exemplary manner of grid generation, once the bounding box data is created, the system 196 may unify the many bounding boxes 256 and may define an outer boundary for multiple subsets of bounding boxes 256, thus created in the virtual map 208 of the worksite 100. The outer boundary may be a continuous outer boundary. A zone 268 (refer FIG. 5) delimited within such a boundary may be split, by the system 196, to generate the grid 216.

At block 904, as the object 212 may move in the virtual map 208, and, more particularly, across the grid 216 provided in the virtual map 208, the system 196 correspondingly detects a number of the passes 224 executed by the object 212 with respect to the cells 220 in the virtual map 208. As an example, each pass 224 executed by the object 212 with respect to the cell 220` may include an entry of the object 212 into the cell 220` and an exit of the object 212 from the cell 220`. For brevity, explanation is made in reference to one cell, i.e., the cell 220`. Similar explanation can be applied to movement of the object in relation to the other cells 220.

For example, for cell 220` in FIG. 6, see a first entry 272 of the object 212 and correspondingly see a first exit 276 of the object 212; a second entry 280 of the object 212 and correspondingly a second exit 284 of the object 212; a third entry 288 of the object 212 and correspondingly a third exit 292 of the object 212; a fourth entry 296 of the object 212 and correspondingly a fourth exit 300 of the object 212; and a fifth entry 304 of the object 212 and correspondingly a fifth exit 308 of the object 212. A movement of the object 212 between the first entry 272 and the first exit 276 in the cell 220 may be regarded as a first pass 312; movement of the object 212 between the second entry 280 and the second exit 284 in the cell 220 may be regarded as a second pass 316; a movement of the object 212 between the third entry 288 and the third exit 292 in the cell 220 may be regarded as a third pass 320; a movement of the object 212 between the fourth entry 296 and the fourth exit 300 in the cell 220 may be regarded as a fourth pass 324; and a movement of the object 212 between the fifth entry 304 and the fifth exit 308 in the cell 220 may be regarded as a fifth pass 328 or a final pass 328` corresponding to the cell 220.

The first pass 312, second pass 316, third pass 320, fourth pass 324, and fifth pass 328, may be singularly or collectively referred to as pass 224 or passes 224. It may be noted that with every pass 224 executed by the object 212, the machine 104 may help the section 252 of the surface 152 achieve a different elevation, so that the section 252 may achieve a desired elevation. In an example, with the first pass 312, the machine 104 may help achieve a first elevation of the section 252; with the second pass 316, the machine 104 may help achieve a second elevation of the section 252; with the third pass 320, the machine 104 may help achieve a third elevation of the section 252; with the fourth pass 324, the machine 104 may help achieve a fourth elevation of the section 252; and with the fifth pass 328, the machine 104 may help achieve a fifth elevation of the section 252. If the machine 104 were to include the compactor 156, the elevation of the section 252 achieved by the machine 104 may, for example, decrease incrementally with every pass 224 from the first elevation to the fifth elevation.

The many entry and exit points or the passes 224 indicated distinctly by way of several linear dotted lines in FIG. 6 is provided solely for example or for illustrative purposes. These passes 224 are not limited to being disposed in a parallel configuration, as may be implicitly suggested from FIG. 6. Persons skilled in the art may contemplate that actual passes defined by a movement of the object 212, such as owing to the motion of the machine 104 at the worksite 100, may include a number of curves, turns, or interruptions. Moreover, such passes may also overlap, or intersect, one another at various places.

At block 906, once the system 196 determines the number of the passes 224 executed by the object 212 with respect to the cells 220, the system 196 determines the first set of cells 228 among the number of cells 220 of the grid 216 for which a count of the passes 224 exceeds a count threshold. In some embodiments, the count threshold may be stored as a predetermined value in the memory 200 and which may be accessed by the system 196 as and when such determination is needed. In some embodiments, in the case of machine 104 being the compactor 156, the count threshold may differ for different materials being compacted by the compactor 156. Therefore, several count thresholds, corresponded against different materials, may be stored, such as by way of a chart or a map, within the memory 200. Each such count threshold may be accessed by the system 196 as and when needed. In some embodiments, the system 196 may assign the first set of cells 228 with a first unique code for easing any later analysis. In some embodiments, the system 196 may assign the first set of cells 228 with a first unique color, such that a viewer of the virtual map 208 may visualize the first set of cells 228 with relative ease.

At block 908, once the first set of cells 228 is determined, the system 196 uses the sensor system 192, such as the telematics data obtained from the sensor system 192 such as the (IMU) sensors or accelerometers of the sensor system 192, to measure a first elevation data and a second elevation data of the machine 104 corresponding to each cell 228 of the first set of cells 228 when the object 212 correspondingly executes a first pass, F, and a second pass, S, with respect to each cell 228 of the first set of cells 228. It will be appreciated that the second pass, S, is executed subsequently to the first pass, F. Further, the first pass, F, may be the same as first pass 312. However, the second pass, S, may not necessarily immediately succeed the first pass, F, as no chronological order of the passes 224 is intended with the use of the terms ‘first’ and ‘second’ for the block 908 and as used for the first pass, F, and the second pass, S. Therefore, it will be appreciated that the expression, second pass, S, applied in the context of the block 908, may not necessarily be same as the second pass 316. To this end, the second pass, S, as applied in the context of block 908, may refer to any of the passes 224 from the second pass 316 to the fifth pass 328, or the final pass 328`. Understandably, therefore, the second elevation data may also correspond to an elevation data associated with any of the second elevation, third elevation, fourth elevation, or the fifth elevation or a final elevation.

Further, as part of block 910, the system 196 compares the second elevation data with the first elevation data. Such a comparison may be performed by the system 196 for each cell 228 of the first set of cells 228. To this end, the system 196 may deduct a value corresponding to the second elevation data from a value corresponding to the first elevation data or vice-versa. In that manner, the system 196 may compute and arrive at an elevation change, or a magnitude of elevation change, for each cell 228 of the first set of cells 228.

As part of block 912, once the system 196 computes the elevation change for each cell 228 of the first set of cells 228, the system 196 identifies the second set of cells 232, such as from the first set of cells 228, for each of which the corresponding elevation change exceeds an elevation threshold. In some embodiments, the elevation threshold may be stored as a predetermined value in the memory 200 and which may be accessed by the system 196 as and when needed. In some embodiments, and as noted above, in the case of the machine 104 is the compactor 156, the elevation threshold may differ for different materials being compacted by the compactor 156. Therefore, several elevation thresholds, corresponded against different materials, may be stored, such as by way of a chart or a map, within the memory 200. Each such elevation threshold may be accessed by the system 196 as and when needed.

In some embodiments, the system 196 may assign the second set of cells 232 with a second unique code so as to be easily perceivable by the system 196 for easing any later analysis. In some embodiments, the system 196 may assign the second set of cells 232 with a second unique color, such that a viewer of the virtual map 208 may visualize the second set of cells 232 with relative ease.

It will be appreciated that the stages of determining the first set of cells, such as corresponding to block 906, and the second set of cells, such as corresponding to blocks 908, 910, and 912, may be performed and may occur one after the other. Also, said stages may be performed by the system 196 in any order and need not necessarily follow the order described above. For example, the system 196 may execute the block 906 after the system 196 executes the block 908, 910, and 912. Effectively, in some cases, it is possible for the system 196 to determine a second set of cells, similarly to the determination of the second set of cells 232, prior to determining a first set of cells, such as the first set of cells 228. In some embodiments, the aforementioned stages may be performed simultaneously by the system 196. Those in the art may contemplate such operations or variations of the system 196 based on the present disclosure.

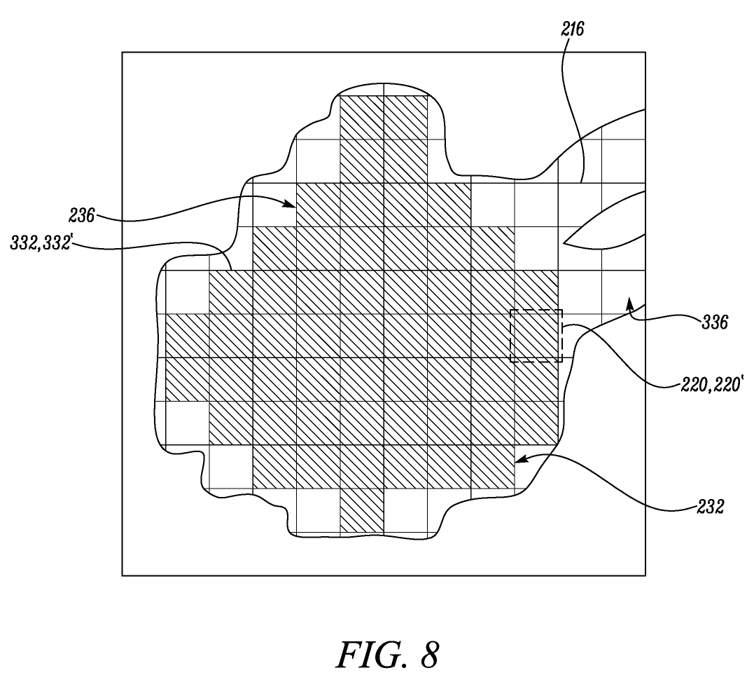

At block 914, the system 196 clusters the second set of cells 232 together to define a polygon 332 in the virtual map 208 of the worksite 100, denoting a work area polygon or a work region 332`, e.g., for the object 212, in the virtual map 208 of the worksite 100. In some embodiments, the system 196 may also cluster the cells 220 falling outside of the first set of cells 228 and the second set of cells 232 to demarcate a non-working region of the worksite 100. In some embodiments, the system 196 may also cluster said cells 220 falling outside the first set of cells 228 and the second set of cells 232 to define a travel region 336 (refer FIG. 8) for the object 212 in the virtual map 208 of the worksite 100.

At block 916, according to some embodiments, the system 196 calculates a volume of earth altered by the machine 104 based on the work region 332` to determine the productivity of the machine 104. In this regard, the system 196, for each cell 232 of the second set of cells 232 of the work region 332`, may measure a work area of a corresponding section, such as the section 252 (refer FIG. 1) of the worksite 100; measure the corresponding elevation change; and obtain a mathematical product between the corresponding elevation change and the work area, thereby deducing a volume corresponding to each cell 232 of the work region defined by the second set of cells 232. Further, the system 196 may summate the products obtained correspondingly to the second set of cells 232 of the work region 332` with each other.

As an example, if the area of the section 252 of the surface corresponding to the cell 220`, which may be determined as one of the second set of cells 232, may be one square meter (i.e., 1 m²) and if the elevation change corresponding to said cell 220` is measured to be 0.25 meter, a volume of earth altered corresponding to the cell 220` may equal a mathematical product of 1 m² and 0.25 m, which is 1 m² x 0.25 m, equaling 0.25 m³. In a similar manner, products corresponding to all the cells 232, such as all of the second set of cells 232, of the work region 332` may be measured and which may then be summated together to arrive at the volume of earth altered by the machine 104.

Further, for each cell 232 of the second set of cells 232 of the work region 332`, the system 196 may compare a final elevation data, e.g., that corresponds to the final pass 328`, with a target elevation data. As with the thresholds discussed above, the target elevation data may also be a predetermined value stored within the memory 200. In some embodiments, the second elevation data may be one and the same as the final elevation data. The system 196 may further determine a productivity shortfall if the final elevation data or the second elevation data is outside a threshold elevation range within which the target elevation data is defined. In some embodiments, the system 196 determines the productivity shortfall in proportion to a variation between the target elevation data and the final elevation data or the second elevation data.

In some embodiments, if the final elevation data, such as for a third set of cells from the second set of cells (not shown) falls within the threshold elevation range, the system 196 may determine that the compaction operation, or the associated operation involving altering earth, for said third set of cells is on target. As a result, the system 196 may consider a work area corresponding to or defined by the third set of cells as a valid work area or an actual productive work area for the worksite 100. The other remaining cells of the second set of cells 232, for which the final elevation data may fall outside the threshold elevation range, may be designated as either excessively altered or insufficiently altered – such as in the case of the compactor 156, under compacted or over compacted. The system 196 may then compare said third set of cells with the second set of cells 232, for which the final elevation data may fall within the threshold elevation range, and issue a notification, such as a KPI based notification, indicating loss of productivity incurred while altering the section, such as section 252, of the surface 152 that may correspond to the third set of cells.

The system 172 allows supervisors, foremen, site managers, crew members, and other individuals associated with the worksite plan to more accurately distinguish the worked areas 108 from the travel areas 112 or other worksite areas. Such distinction helps exclude areas other than the worked areas for the calculation of the volume of earth altered. Therefore, machine productivity is more effectively and accurately determined as said volume of earth altered is directly linked with productivity. Moreover, the system 172 allows for an improved optimization in the utilization of a machine fleet. Applying the system 172 also saves time and effort, as otherwise manual interventions and decision making may be needed in accurately determining machine productivity.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the disclosure, especially in the context of the following claims, are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method or system of the present disclosure without departing from the scope of the disclosure. Other embodiments will be apparent to those skilled in the art from consideration of the specification and practice of the method or system disclosed herein. It is intended that the specification and examples be considered as examples only, with a true scope of the disclosure being indicated by the following claims and their equivalent.

What is claimed is:

1. A method for determining productivity of a mobile machine configured to alter earth at a worksite, the method comprising:
generating, by a system, a grid in a virtual map of the worksite, the grid defining a plurality of cells;
detecting, by the system, at least one pass executed by an object with respect to the plurality of cells in the virtual map, the object representative of the mobile machine;
determining, by the system, a first set of cells from the plurality of cells for which a count of passes exceeds a count threshold;
using, by the system, a sensor system to measure a first elevation data and a second elevation data of the mobile machine corresponding to each cell from within the first set of cells when the object correspondingly executes a first pass from within the at least one pass and a second pass from within the at least one pass with respect to each cell from within the first set of cells;
comparing, by the system, the second elevation data with the first elevation data corresponding to each cell from within the first set of cells to compute an elevation change for each cell from within the first set of cells;
identifying, by the system, a subset of cells or a second set of cells from the first set of cells for which the elevation change exceeds an elevation threshold;
clustering, by the system, the second set of cells to define a work region in the virtual map of the worksite; and
calculating, by the system, a volume of earth altered by the mobile machine based on the work region to determine the productivity of the mobile machine.

2. The method of claim 1, wherein each pass from the at least one pass executed by the object with respect to each cell from the plurality of cells includes:
an entry of the object into a corresponding cell and an exit of the object from the corresponding cell.

3. The method of claim 1, wherein
in the virtual map, the at least one pass of the object with respect to the plurality of cells corresponds to a movement of the object in the virtual map, the movement of the object in the virtual map occurring coterminous with a motion of the mobile machine at the worksite, and
the grid is generated based on the movement of the object in the virtual map of the worksite.

4. The method of claim 3, wherein generating the grid on the virtual map based on the movement of the object includes:
creating, by the system, bounding box data for the object, the bounding box data including a plurality of bounding boxes generated in series and in alignment with a path formed by the movement of the object in the virtual map; and
splitting, by the system, the plurality of bounding boxes into the plurality of cells to generate the grid.

5. The method of claim 1, wherein for each cell of the second set of cells of the work region, the method further including:
measuring, by the system, a work area of a corresponding section of the worksite;
determining, by the system, a corresponding elevation change;
obtaining, by the system, a mathematical product of the corresponding elevation change and the work area; and
calculating the volume of earth includes summating, by the system, products obtained correspondingly to the second set of cells of the work region with each other.

6. The method of claim 1 further including:
for each cell of the second set of cells of the work region,
comparing, by the system, the second elevation data or a final elevation data with a target elevation data; and
determining, by the system, a productivity shortfall if the second elevation data or the final elevation data is outside a threshold elevation range within which the target elevation data is defined.

7. The method of claim 6, wherein,
subsequent to the first pass, the second pass is executed, and
the productivity shortfall is determined in proportion to a variation between the target elevation data and the second elevation data or the final elevation data.

8. The method of claim 1, wherein the plurality of cells are uniformly sized.

9. The method of claim 1, wherein each cell from the plurality of cells is square shaped, rectangular shaped, or polygonal shaped.

10. The method of claim 1 further including:
clustering, by the system, cells of the plurality of cells falling outside the first set of cells or the second set of cells to define a travel region in the virtual map of the worksite.

11. A system for determining productivity of a mobile machine configured to alter earth at a worksite, the system comprising:
a sensor system configured to measure an elevation data of the mobile machine; and
a system configured to:
generate a grid in a virtual map of the worksite, the grid defining a plurality of cells;
detect at least one pass executed by an object with respect to the plurality of cells in the virtual map, the object representative of the mobile machine;
determine a first set of cells from the plurality of cells for which a count of passes exceeds a count threshold;
use the sensor system to measure a first elevation data and a second elevation data of the mobile machine corresponding to each cell from the first set of cells when the object correspondingly executes a first pass from within the at least one pass and a second pass from within the at least one pass with respect to each cell from within the first set of cells;
compare the second elevation data with the first elevation data corresponding to each cell from within the first set of cells to compute an elevation change for each cell from within the first set of cells;
identify a subset of cells or a second set of cells from the first set of cells for which the elevation change exceeds an elevation threshold;
cluster the second set of cells to define a work region in the virtual map of the worksite; and
calculate a volume of earth altered by the mobile machine based on the work region to determine the productivity of the mobile machine.

12. The system of claim 11, wherein each pass from the at least one pass executed by the object with respect to each cell from the plurality of cells includes:
an entry of the object into a corresponding cell and an exit of the object from the corresponding cell.

13. The system of claim 11, wherein
in the virtual map, the at least one pass of the object with respect to the plurality of cells corresponds to a movement of the object in the virtual map, the movement of the object in the virtual map occurring coterminous with a motion of the mobile machine at the worksite, and
the grid is generated based on the movement of the object in the virtual map of the worksite.

14. The system of claim 13, wherein to generate the grid on the virtual map based on the movement of the object, the system is configured to:
create bounding box data for the object, the bounding box data including a plurality of bounding boxes generated in series and in alignment with a path formed by the movement of the object in the virtual map; and
split the plurality of bounding boxes into the plurality of cells to generate the grid.

15. The system of claim 11, wherein, for each cell of the second set of cells of the work region, the system is configured to:
measure a work area of a corresponding section of the worksite;
determine a corresponding elevation change;
obtain a product between the corresponding elevation change and the work area; and
to calculate the volume of earth, the system is configured to summate products obtained correspondingly to the second set of cells of the work region with each other.

16. The system of claim 11, wherein the system is configured to:
for each cell of the second set of cells of the work region,
compare the second elevation data or a final elevation data with a target elevation data; and
determine a productivity shortfall if the second elevation data or the final elevation data is outside a threshold elevation range within which the target elevation data is defined.

17. The system of claim 16, wherein,
subsequent to the first pass, the second pass is executed, and
the system is configured to determine the productivity shortfall in proportion to a variation between the target elevation data and the second elevation data or the final elevation data.

18. The system of claim 11, wherein the plurality of cells are uniformly sized.

19. The system of claim 11, wherein each cell from the plurality of cells is square shaped, rectangular shaped, or polygonal shaped.

20. The system of claim 11, wherein the system is configured to:
cluster cells from the plurality of cells falling outside the first set of cells or the second set of cells to define a travel region in the virtual map of the worksite.
